(19) United States
(12) Patent Application Publication
(10) Pub. No.: US 2007/0199013 A1
(43) Pub. Date: Aug. 23, 2007

(54) DIGITAL SIGNATURES

(75) Inventors: Ravosh Samari, Airdrie (CA); Paymaan Behrouzi, Airdrie (CA)

Correspondence Address: BANNER & WITCOFF, LTD., TEN SOUTH WACKER DRIVE, SUITE 3000, CHICAGO, IL, 60606, US

(73) Assignees: TAYLOR NELSON SOFRES PLC, London (GB); MEDIA EVOLUTION TECHNOLOGIES INC., Airdrie (CA)

(21) Appl. No.: 11/677,463

(22) Filed: Feb. 21, 2007

(30) Foreign Application Priority Data
Feb. 22, 2006 (EP) 06250932.8

(51) Int. Cl. H04N 7/16; H04H 9/00

(52) U.S. Cl. 725/20; 725/21; 725/19

(57) ABSTRACT

Method and apparatus for generating a digital signature are provided. The method comprises:—polarizing a sampled data segment, for example a sampled audio segment, to produce a two-state signal having a bit sequence providing a binary representation of the sampled data segment, detecting an event in the signal, the event corresponding to occurrence of a predetermined pattern in the bit sequence of the signal, selecting, on the basis of a predetermined signature collection pattern specifying a plurality of offsets from the detected event, the values of the respective bits of the bit sequence at the bit positions specified by the offsets, and on the basis of those values providing a digital signature characteristic of the sampled data segment. Related systems are also provided.

### PRIORITY INFORMATION

This application claims the benefit of priority of European Patent application No. 06250932.8 filed Feb. 22, 2006, the contents of which are incorporated by reference in its entirety.

### FIELD OF THE INVENTION

The present invention relates to digital signatures, for instance digital audio signatures, and to apparatus and methods for generating digital signatures. The present invention is also concerned with audience measurement systems.

### BACKGROUND OF THE INVENTION

Audience measurement/analysis systems, for measuring/analysing TV or radio audiences for instance, commonly make use of so-called meters installed in a panel of households, generally chosen such that their occupants are demographically representative of the potential audience population as a whole.

The meters are devices which monitor the channels, stations or programs selected for viewing or listening on a TV or radio in the household, and typically record information concerning the selected channels, stations or programs for sending, for example by telephone line or other means of communication, to a “central” or “reference” office at which viewing/listening information from households in the panel is collected for analysis.

In the central or reference office all or many channels, stations or programs available for viewing or listening may be monitored and information concerning those channels, stations or programs stored as reference information. Reference information may also be obtained from other sources. For example information concerning programs broadcast on a particular channel or station over a period of time may be obtained directly from the broadcasting company. The information from households may then be analysed to reveal channels, stations or programs selected for viewing in the households, by comparison of information from the households with the reference information.

Various techniques for household monitoring of channels, stations or programs have been put to use. Similar techniques may in general be used in the central or reference office for monitoring all or many channels, stations or programs available for viewing or listening.

One technique used is to directly monitor tuning circuits in a TV or radio set, to gain information about the channel (frequency) to which the set is tuned. Another technique is to monitor special identification codes embedded in program signals, for example as broadcast or delivered by a service provider. The codes are embedded “at source” in the program signal by the service provider, for example in an audio signal component, or in an video signal component if video is involved. Such embedded codes typically identify the broadcasting station, and may also containing information identifying the program carried by the station at any given time. A third technique is to derive, from a program selected for viewing or listening, a signature characteristic of the program. The signature may be derived from audio or video. Such a signature is not embedded in the program signal at source, but is derived or generated from the program signal at the point of viewing or listening in a household.

Each of these methods has been perceived to have disadvantages.

Directly monitoring tuning circuits typically requires physical entry into and modification of a TV or radio set concerned, and is therefore undesirably invasive.

Monitoring embedded identification codes, even if physical entry into and modification of a TV or radio set concerned is not always needed, effectively requires such codes to be embedded at source and to be reliably detectable in all, or substantially all, programs. If this is not the case, the information obtained is at best incomplete, likely to the extent that it is of little or no utility.

The use of signatures has been considered to be demanding in terms of cost and the hardware needed, and susceptible in practice to program identification problems due to inconsistencies between signatures generated, on the basis of the same original program content, under the different conditions which may apply at different locations and different times. The different conditions may arise as a result of different program reception conditions or equipment capabilities at different times or locations.

### SUMMARY OF THE INVENTION

According to the present invention there is provided digital signature generation apparatus as claimed in claim 1.

According to the present inventions there is provided a method of generating a digital signature as claimed in claim 16.

In the context of digital audio signatures, embodiments of the present invention can provide for the efficient generation of essentially unique digital signatures from segments of audio—useable for identification of the audio—in a repeatable way such that if a signature is generated at a different time or location from substantially the same source audio (even with some level of distortion) an exact or very similar digital signature is generated.

In the context of digital audio signatures, embodiments of the present invention can also provide for an efficient lookup system which is able to accurately identify the audio segment from which a signature is derived by comparison with (lookup in) a very large database of reference digital signatures.

For example digital signatures generated from a broadcast program selected for viewing or hearing in a household can be compared with reference signatures generated in a central or reference office from all broadcast programs received at the central office and stored in a database of reference signatures at that office or a further location.

In the context of digital audio signatures the term program should be understood to mean a program or program segment made available by any means of distribution, such as by terrestrial broadcast, by satellite, by cable distribution, via the internet, via fixed or mobile telephony or data distribution, or any other means of communication. The term program should also be understood to include programs or program segments distributed on or available from any storage medium, such as video tape, DVD, audio tape, audio CD, music players based on MP3 or any other format.

Although the present invention finds an important application in the context of digital audio signatures, the inventors have had the insight that the invention can be used to provide digital signatures characteristic of signals or data of the most varied kinds. For example, embodiments of the present invention can provide for the efficient generation of essentially unique digital signatures from segments of video—useable for identification of the video—in a repeatable way such that if a signature is generated at a different time or location from substantially the same source video (even with some level of distortion) an exact or very similar digital signature is generated. In the context of digital video signatures, embodiments of the present invention can also provide for an efficient lookup system which is able to accurately identify the video segment from which a signature is derived by comparison with (lookup in) a very large database of reference digital signatures.

Beyond this, embodiments of the present invention can also provide for generation of digital signatures from signals or data of other kinds. In principle, the present invention can be applied any signal or data because the invention is not concerned with the content of the signal or data and is not concerned with reproduction of the signal or data. A signature can be generated not only from an audio segment, or a video segment, but from any data segment, regardless of the information content of the data segment. For example, the data segment may be a signal or data representing a scanned human fingerprint or a retina scan. The data segment may represent a “voiceprint” (e.g. a person speaking a password or password phrase). Basically any type of signal or data may be the subject of digital signature generation in accordance with the present invention. Clearly, embodiments of the present invention can find application in any context in which a digital signature generated from an original data segment is used for verification or for identifying a match in a database of reference signatures, such as a database of reference signatures based on human fingerprints or retina scans for instance.

### BRIEF DESCRIPTION OF THE DRAWINGS

FIG. 1 is a schematic illustration of equipment provided in a household, for monitoring programs selected for viewing or listening on a TV or radio or other entertainment equipment in the household, including apparatus in accordance with an embodiment of the present invention,

FIG. 2 is a schematic illustration of equipment provided in a central or reference office, for monitoring broadcast programs, and analysing viewing or listening information received from households, including apparatus in accordance with an embodiment of the present invention,

FIG. 3 is a schematic flow diagram of the steps in method of generating digital signatures in accordance with an embodiment of the present invention,

FIG. 4 is a schematic waveform diagram which illustrates two different polarization techniques which may be employed in embodiments of the present invention for reducing a filtered digital audio sample to a two-state (“1”/“0”) or binary representation,

FIG. 5 is a schematic diagram illustrating one possibility for identifying synchronization events in a bit pattern of a reduced and filtered digital audio sample, which may be used in embodiments of the present invention,

FIG. 6 is a schematic diagram illustrating one possibility for generating a digital signature of a reduced and filtered audio sample keyed to an identified synchronization event, which may be used in embodiments of the present invention, and

FIG. 7 is a schematic waveform diagram illustrating two waveforms and detail differences between transition points of the two waveforms.

### DETAILED DESCRIPTION

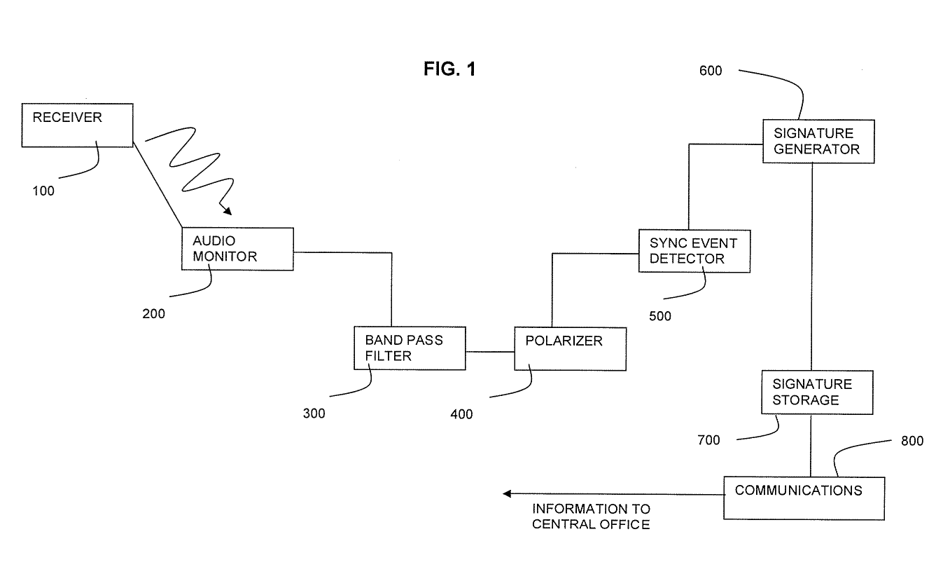

FIG. 1 is a schematic illustration of equipment provided in a household for monitoring programs selected for viewing or listening on a TV or radio or other entertainment apparatus in the household, including apparatus in accordance with an embodiment of the present invention.

The equipment includes at least one apparatus, for example a TV or radio receiver 100, the programs viewed or heard on which are the subject of monitoring for audience analysis purposes.

An audio monitor 200 is associated with the receiver 100, which monitor is capable of detecting audio segments associated with the programs viewed or heard on the receiver 100. The audio segments may be detected for example electrically, in which case the audio monitor 200 is electrically connected with the receiver 100. Alternatively, the audio segments may be detected as sound waves, as schematically illustrated in FIG. 1. For this alternative, the audio monitor requires a suitable audio detector such as a microphone.

An advantage of the latter alternative is that the audio monitor may be associated with an individual person, e.g. worn by the person, so that individualized viewing/listening data can be acquired for different persons in the household, regardless of the particular source (e.g. particular receiver 100) of the detected audio segments.

Of course, the apparatus indicated in this example to be a TV or radio receiver could include other functions such as the ability to play video tapes, DVDs, audio CD's, etc. The apparatus in some cases may have no receiver function. The present invention can be used to monitor any source of audio segments.

In accordance with this embodiment of the present invention, the audio signal detected by the audio monitor 200 is digitized (if not received in digital form) and sampled. The sampling may be intermittent, e.g. with a series of sampled audio segments of selected length being provided at selected intervals, or may be continuous, so that a continuous digital sampled audio segment stream is provided.

Measures may be taken to suspend sampling if the detected audio level is below a threshold.

The sample segments are passed to a band pass (or low pass) filter 300, which operates to reduce the bandwidth of the segments, as a first step in production of digital signatures from the sampled segments. This is explained in more detail below.

In some cases, the low pass or band pass filtering function may be incorporated in the audio monitor. The filtering may be applied to the audio signal while that signal is in analog form (i.e. prior to digitization) or at the point of digitization of the analog audio signal.

The filtered sampled segments are then passed to a polarizer 400 which operates to reduce the digital values contained in the segments merely to “polar” values, i.e. “1” and “0”. The polarizer 400 thus reduces the segments to sequences of bits, i.e. to binary representation. This is explained in more detail below.

The polarized sampled segments are then passed to a synchronization event detector 500. The detector 500 scans the sample segments for predetermined events, for example a reversal of polarization of successive bits (that is, a change from “1” in one bit position to “0” in the next bit position in the sample). Such an event, when detected by the detector 500, acts as a key or starting point for the generation of a digital signature of a sampled segment. This is explained in more detail below.

It should be noted that in some embodiments of the present invention the synchronization event detector may scan filtered sampled segments before polarization, for example scanning the samples for peaks and/or valleys as the predetermined events. This is explained in more detail below.

A signature generator 600 operates to extract from a polarized sampled segment the values of a number of bits of the segment, which bits are at predetermined positions in relation to an event detected by the synchronization event detector 500. The predetermined positions are set by a digital signature collection pattern which specifies the offsets of the bit positions from a detected event. The offsets may be either positive (corresponding to a bit position after the detected event) or negative (corresponding to a bit position before the detected event). For example, the values of 48 bits may be extracted in this way.

The values of extracted bits, arranged in a predetermined order, for example in order of increasing offset from the detected event, provide a digital signature of the sampled segment concerned. The numerical value of the ordered bits may be used as the digital signature and/or the pattern of the ordered bits may be used as the digital signature.

Digital signatures can be obtained in this way for every detected event in a sampled segment, or only for one or some events. This is explained in more detail below.

The obtained digital signatures are stored in signature storage 700, generally together with time stamp information indicating the times at which the signatures were obtained. The storage 700 thus accumulates over time a record of programs viewed or listened to in the household.

Periodically, the information in storage 700 can be downloaded to a central or reference office for analysis, via communications means 800, for example using a modem and telephone line.

Alternatively, the storage 700 may be a module which can be removed and dispatched to the central or reference office for example by post, or collected. The module is then replaced by a new module to record further information.

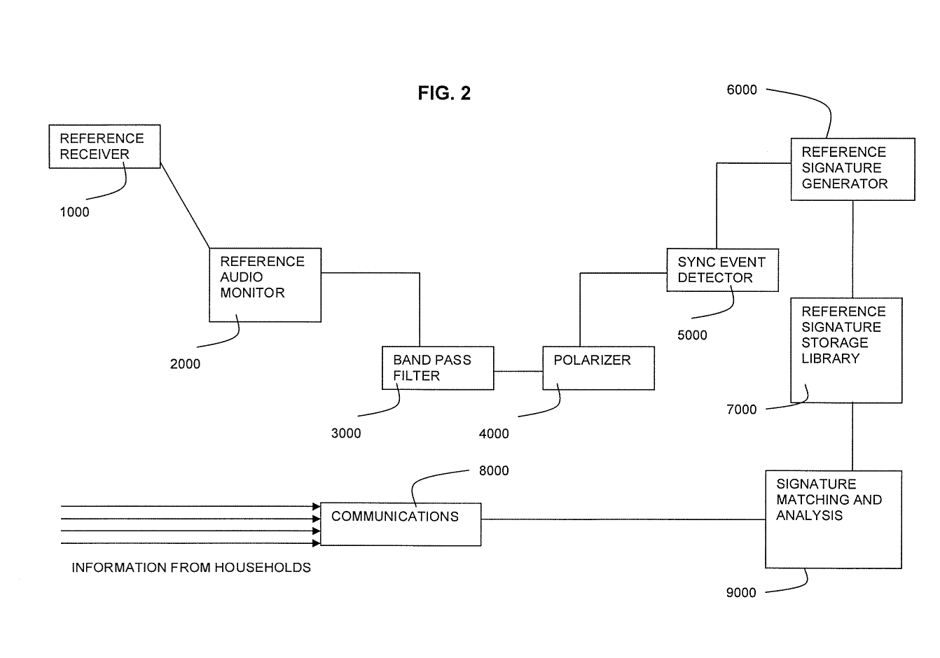

FIG. 2 is a schematic illustration of equipment provided in a central or reference office, for monitoring broadcast programs, and analysing viewing or listening information received from households, including apparatus in accordance with an embodiment of the present invention.

The equipment comprises reference receiver 1000, capable of receiving programs from a number of sources, such as terrestrial broadcasts, and programs delivered via satellite, cable etc. Ideally all such program sources which could be received in monitored households should be received be the reference receivers 1000.

Reference audio monitor 2000, low pass or band pass filter 3000, polarizer 4000, synchronization event detector 5000 and reference signature generator 6000 function comparably to the equivalent items (200, 300, 400, 500 and 600 respectively) provided in a household as illustrated in FIG. 1. However, in the central or reference office the relevant items have the capacity to process audio segments derived from all the monitored sources in parallel. In particular, the synchronization event detector 5000 and reference signature generator 6000 may also, for each sample processed, obtain a greater number of signatures, based on a greater number of detected events in the sample, than is the case in household equipment. This is explained in more detail below.

The signatures obtained are stored in a reference signature storage library or database 7000, and made available to a signature matching and analysis facility 9000 which can compare the reference signatures with signatures in information received from households via a communications facility 8000.

The reference signature library may also contain reference signatures obtained from other (e.g. non-broadcast) program sources, for example from programs on DVD's, audio CD's etc.

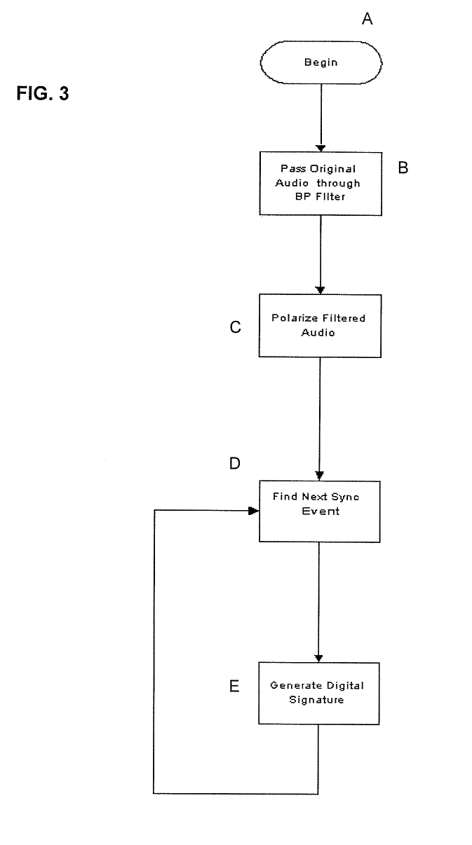

FIG. 3 is a flow chart which schematically illustrates the steps in a method embodying the present invention for the generation of digital audio signatures.

The method begins at step A, where an original audio segment is obtained. The original audio segment is subject digital band pass (or low pass) filtering at step B, producing a filtered digital segment. Of course, digitization may be effected as a precursor to filtering. In some cases, filtering may be effected at least in part in the analog domain.

In step C, the filtered segment is polarized; that is, the digital values contained in the filtered segment are reduced merely to “polar” values, i.e. “1” and “0”. This results in a sequence of bits, i.e. to a binary representation. This is explained in more detail below.

In step D, the polarized segment is scanned for predetermined events, for example a reversal of polarization of successive bits (that is, a change from “1” in one bit position to “0” in the next bit position in the signal). Such an event, when detected, acts as a key or starting point for the generation of a digital signature. This is explained in more detail below.

In step E, the values of a number of bits are extracted from the polarized segment, which bits are at predetermined positions in relation to an event detected in step D. The predetermined positions are set by a digital signature collection pattern which specifies the offsets of the bit positions from a detected event. The offsets may be either positive (corresponding to a bit position after the detected event) or negative (corresponding to a bit position before the detected event). For example, the values of 48 bits may be extracted in this way. The values of extracted bits, arranged in a predetermined order, for example in order of increasing offset from the detected event, provide a digital signature of the sample concerned. The signature may be the numerical value represented by the bits, and/or the pattern of the bits, as mentioned above.

When a signature has been extracted based on one detected event, this is repeated for a next event detected in step D, as indicated in FIG. 3. Thus, a series of digital signatures, effectively triggered by successive detected events, are generated.

Further details and aspects of preferred embodiments of the present invention, apparatus and method, will be now explained below.

As mentioned above, embodiments of the present invention can be used to provide digital signatures other than digital audio signatures. The signals or data segments to which the present invention can be applied to produce digital signatures may be of the most varied kind. In particular any signal that exists in the analog domain is a candidate for the present invention, though signals in the digital domain can be handled. The filtering can occur in the analog domain (or both analog and digital domains—some filtering in the analog domain before sampling, and then some digital filtering after).

Embodiments of the present invention employ digitized sampled segments. While the sampling frequency and resolution are arbitrary, for simplicity and consistency they should stay fixed across a system. For example in an audience monitoring system comprising household apparatus as illustrated in FIG. 1, and central office or reference office apparatus as illustrated in FIG. 3, the same sampling frequency and resolution should be used in the household and reference office apparatus.

In a preferred implementation of embodiments of the invention, 8000 Hz sampling and 16-bit resolution per sample are employed.

Each data segment, e.g. audio segment, is first filtered (band pass or low pass), preferably using an input digital filter. There are many digital filters and filtering techniques that are acceptable. However, the use of a 500-tap band pass FIR filter with pass band 100 Hz to 300 Hz has been found to be particularly favourable.

Optionally, in embodiments of the invention, more than one filter, or more than one filtering step, can be used in parallel resulting in more than one filtered data segment that subsequently can be operated on individually and separately.

The goal of polarization of the data in embodiments of the present invention is to reduce each of the digital samples of the filtered data to a simple two state (binary) representation.

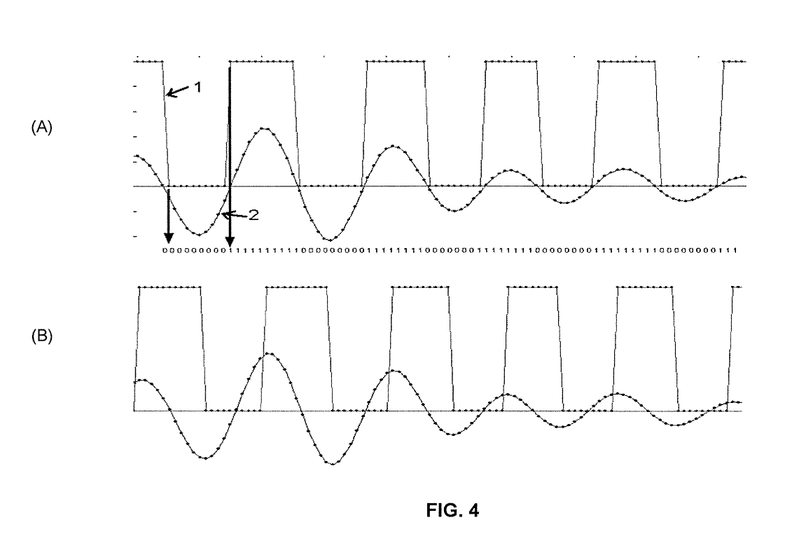

More than one technique can be employed to polarize. Referring to FIG. 4, two exemplary methods are illustrated.

At (A) in FIG. 4, a pole-crossing technique is shown whereby every sample of the audio waveform 2 that has a value greater than zero is converted to a “1” and every value less than or equal to 0 is converted to 0. In (A) in FIG. 4, 1 represents the polarized array of the audio waveform 2.

At (B) in FIG. 4, an alternate technique for polarizing an audio waveform is shown. In this technique, whenever a crest is detected, either positive or negative, the state of the polarity bits is reversed.

The end result in both polarizing techniques is an array consisting solely of 1's and 0's, herein called a polarized array (PA). This array is a representation of the original data segment (e.g. audio segment) and can be expected to have a high level of uniqueness for every unique piece of audio (or other data, such as scanned human fingerprint data) that can ever exist, provided it is not so short as to cause the uniqueness to be compromised.

Synchronisation event location identification is a process whereby an event is detected which can be employed effectively as a synchronization point. Such an event or synchronization point should be such that it can be determined or detected in a repeatable manner so that if the same data (e.g. same audio), even with some distortion or injected noise, is again subject to signature generation, the same synchronisation point will be found. For example, an event or synchronization point detected in audio at a central or reference office should also be detected, even if some distortion or noise is present, in the same audio when reproduced and monitored in a household.

It has been determined that many such events or synchronization points will normally be found in a typical data segment (e.g. audio segment) or polarized array, each of which can be used as a starting point to generate a digital signature. However, it is possible to select only the best ones and use those and ignore the rest.

The advantage of using an event or synchronization point is that a common starting point (when considering two data segments, e.g. two audio segments) at which to begin generating a digital signature is used thereby ensuring that the digital signatures will be the same. The advantage of selecting only the best of the synchronization points and ignoring the rest is that the volume of data is greatly decreased without compromising overall accuracy of the system.

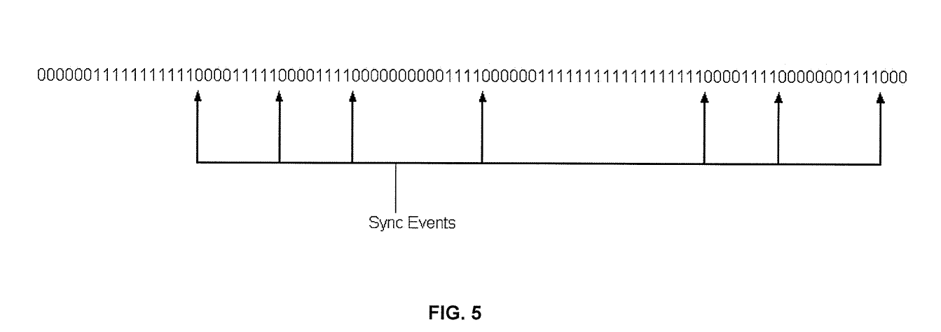

By way of example, referring to FIG. 5, whenever a transition between a ‘1’ and a ‘0’ is detected, this is considered to be a Sync Event. Note that due to the band pass (or low pass) filtering, with an appropriate digital sampling rate, there will always be a string of ‘1’s followed by a string of ‘0’s.

The occurrence of other transitions or bit patterns in the polarized array may be employed as synchronisation events or synchronization points, depending for example on the sampling rate and filtering employed.

For example, it is possible to look at a moving window of bits (e.g. 64 bits) and sum the number of 1's (or 0's) in that window. If the sum has a particular value, for example corresponding to half the total number of bits in the window, or falls within a predetermined range (for example falling within a predetermined range of the certain value), for instance 28, 29, 30, 31, or 32, this could be employed as a synchronisation event.

In general, the principle involved is to have a moving window across the polarized array that looks for a pattern.

It is also possible to employ synchronisation events based on the digitized (but not yet polarized) bits of a sampled data segment, for example by identifying peaks or valleys. A peak is found for example by comparing each sample to the one before it. If samples were increasing in value (‘uphill’) and then the next sample is less than the one before it, this can be used as a synchronisation event. If samples were decreasing in value (‘downhill’) and the next sample is greater than the previous, this can be used as a synchronisation event.

Further, it is possible to consider every nth sampled bit (where n is, for example 1, 2, 3 etc.) as a synchronisation event. A special case is when n=1, i.e. a case in which every single sampled bit is detected as a synchronisation event. This is viable in particular when sampling slowly, e.g. less than 8000 samples per second. It is thus possible to use every single sampled bit as a starting point for collecting a digital signature.

Generally, after all the synchronisation events are identified within a data segment (e.g. audio segment), a further step is taken to select only a few of the prime ones (for example eight in the case of reference signature generation to provide a source reference signature database or library, and for example one in the case of a household meter generating digital audio signatures, or for instance a scanner scanning a human fingerprint for verification against a reference digital fingerprint signature database). This may for example be achieved by splitting the original data segment (e.g. audio segment) into further blocks of time and then finding the location of the maximum amplitude within each and then selecting the synchronisation event immediately before that point in time.

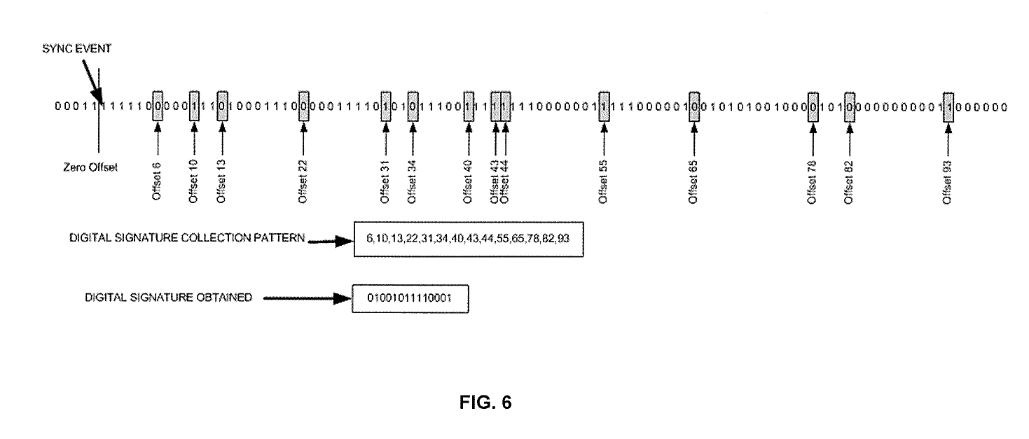

Referring to FIG. 6, using a prime Sync Event, obtained as explained above, as starting point in the polarized array (PA) a digital signature is now obtained by accumulating bits at specific locations in the polarized array (PA). Which bits to accumulate is dictated by a Digital Signature Collection Pattern (DSCP). The DSCP is a set of numbers representing offsets (which numbers could be positive and/or negative, although only positive is shown in the example) from the Sync Event as shown in FIG. 6.

The size of the digital signature is dictated by the number of offset locations chosen in the DSCP. Typically, 48 bits may be used as the size of the signature, although the size may be greater or smaller than this.

Merely for the purpose of illustration, FIG. 6 shows a 14 bit digital signature obtained using a DSCP having 14 elements.

Typically a longer digital signature is desirable in order to increase the number of possible permutations of the digital signature and increase its uniqueness. The end result is a digital signature that looks like the 14 bit number in FIG. 6. This number can then be represented in a decimal format for easier sorting and searching etc.

It should be noted that it is preferable to select the elements (offsets) of the DSCP in such a way as to increase the ‘randomness’ of the bits that will be obtained for the digital signature. If a band pass, or low pass input filtering is used, there will generally always be a string of ‘1’s or ‘0’s because high frequency content will have been removed (for example from the original analog audio or other original data segment). Therefore, the numbers selected for the DSCP are typically chosen to jump around far away enough from each other to eliminate the chance of gathering many ‘1’s (or ‘0’s) from the same string of ‘1’s (or ‘0’s) as this would reduce overall uniqueness of the digital signature.

As mentioned above, the values of extracted bits, arranged in a predetermined order, for example in order of increasing offset from the relevant synchronisation event, provide a digital signature of the sample concerned.

It has been determined that in some cases there may be some merit to using different step sizes (different increments between offsets) in collecting the signature. This may be the case if the sampled data segment (e.g. audio segment) happens to be mainly of, in effect, a single frequency (for example resembling a sampled sine wave), because if a collection pattern having the same offset between bits is then used it is possible to obtain as signature with a 010101010101 pattern, that will not be unique. Thus, it might for example be advantageous to have longer step sizes (increments between offsets) in some parts and smaller in others.

Each time a digital signature is obtained (associated with each Sync Event), a timestamp related to or within the data segment (e.g. audio segment) may be recorded if appropriate.

All reference digital signatures, for example obtained or held in a central or reference office, can then kept together in a database or library allowing easy future lookup.

With this database of digital signatures, if a random data segment is now chosen, for example a segment of audio from the audio stream of a program playing on a TV in a monitored household, and a digital signature obtained from the relevant data segment, then it is possible to identify if that data (e.g. audio) exists in the database by comparing the (e.g. household) digital signature with the elements in the database. If a match is found, the source of the data segment (e.g. a TV or radio program the source of an audio segment, or the identity of the person having the fingerprint which has been scanned) can be identified.

If appropriate, reference signatures in the database, for comparison with a digital audio signature obtained in a household, can be restricted on the basis of timestamps of the signatures so that only reference signatures having timestamps close to that of the household signature are used for comparison. Of course, it is also possible to carry out digital audio signature comparisons without regard to timestamps, for example to identify audio originating from a DVD or audio CD rather that from a TV or radio program transmitted at a particular time.

Some additional measures may be taken, if appropriate or necessary, to facilitate use of embodiments of the present invention,

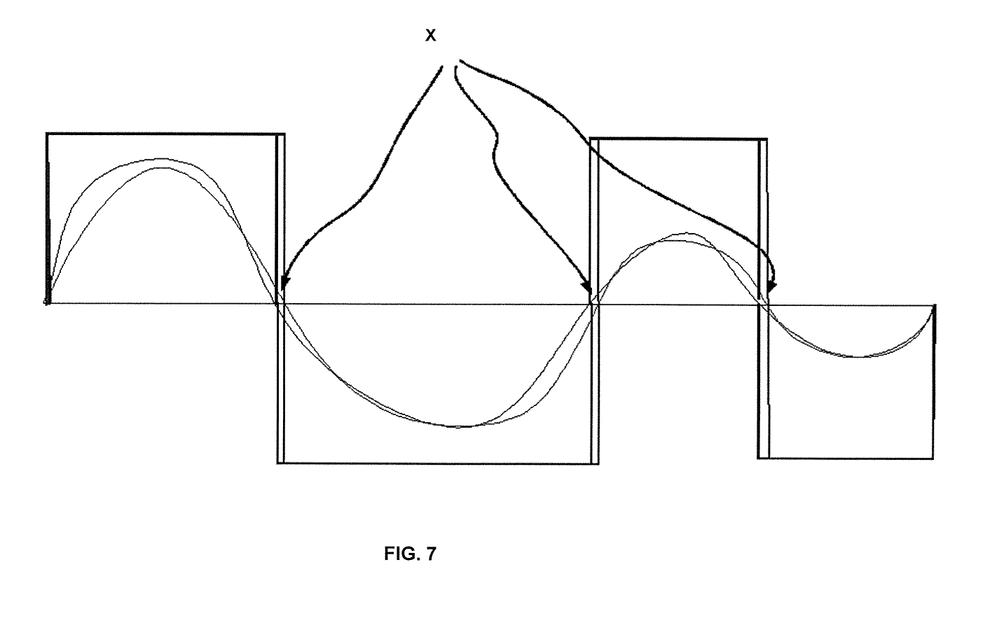

For example, when the signature is the pattern, rather than the numerical value, of its component bits it is probable that a small percentage of individual bits in a digital signature to be identified (e.g. an audio signature generated in a household) will be different as compared with a database reference signature. This is primarily due to slight differences between the analog to digital conversions and signal distortion (for example in the audio in the case of audio signatures). Referring to FIG. 7, some possible problem areas are indicated by X, corresponding to transition areas. Generally, the more transition areas exist in the data (e.g. audio) (post filtered) being used to generate a digital signature, the greater number of bits that will statistically be different between a reference signature in the database and a signature to be identified. To decrease the number of transitions within the window of interest, a lower frequency band pass filter may be used, and the size of the window (size or length of a sample segment) may be decreased. It should be taken into account that these steps have tradeoffs: using a window that is too small decreases uniqueness and increases false positives.

Further, during the lookup phase, when a digital signature to be identified is being looked up in the reference signature database, a small number of bits in the digital signature may be allowed to be different. For example, using a 48 bit digital signature, 1, 2, 3, or 4 bits in the digital signature to be identified may be allowed to differ from a reference signature, with the signatures still being considered to match despite this difference.

As a further refinement, in an embodiment of this invention, bits in the digital signature where situated ‘near’ a transition point of opposite polarity (i.e. a transition from “1” to “0”, or vice versa, in the polarized array) may be identified and, using this information, only these identified bits in the digital signature allowed to be considered as possibly wrong (e.g. being allowed to differ from a reference signature, with the signatures still being considered to match despite this difference).

For example, referring to FIG. 6, assume that a sync event has been identified and bits that will form a digital signature are being collected. As explained above, this is done by jumping out from the sync event or sync point and taking the values of bits of the polarized array at particular offsets (as dictated in the DSCP) from the sync point. Note that the polarized array consists of what looks like pulses (i.e. a series of 1's followed by a series of 0's, followed by a series of 1's, etc.). Now, considering the example polarized array of FIG. 6, if a bit of which the value is to be taken (in accordance with an offset of the DSCP) is in the middle of the first pulse (on the left of the diagram of FIG. 6: i.e. the first series of 1's, considered a “positive” pulse)—say the bit at offset 2—this bit is considered as a (definite) ‘1’. However, if the bit of which the value is to be taken lies towards the end of the first pulse, within some predetermined distance (in terms of bit positions) considered to be very close to the edge at which this “positive” pulse suddenly becomes a “negative” pulse (i.e. the bits change to 0's), for example the bit at offset 4 or 5, then this is still considered as a ‘1’, but this bit is identified as a possible ‘offending’ (possibly wrong) bit. This, for example, takes account of the possibly problematic transition areas shown in FIG. 7.

Considering all the bits making up a signature (having offsets from the sync point in accordance with the DSCP) the will be a 48-bit digital signature, where for example three bits, e.g. bits 12, 22, and 35, are all identified as very close to such an edge (positive pulse changing to negative, or vice versa). (N.B. this is not illustrated in FIG. 6, which only shows a 14 bit signature.)

Using this information, permutations of the digital signature can be generated by allowing bits 12, 22, and 35 to switch their value. This will give rise to eight additional digital signatures which are all permutations of the original.

This can afford a significant advantage because all nine signatures (the eight permutations, plus the original digital signature) can be used for look up in the database. If any of these nine signatures finds a perfect match, then this is considered to be a match. The look up may be bit-wise, or the permutated signatures can be converted to numerical values (e.g. decimal numbers) to perform lookups (for nine numerical values) in a database.

Of course, the number of bits identified as possibly “offending” may be more or less than three. Restrictions may be placed on the number (e.g. 1, 2, 3 or 4), and/or locations in the signature, of possibly “offending” bits taken into consideration. For example, only a maximum of three possibly “offending” bits may be taken into consideration, possibly those at locations most proximate the sync event.

Such a technique of identifying ‘offending’ bits in the digital signature, can allow the number of permutations to be looked up to be restricted in meaningful manner. Without such restriction, it may be necessary to allow each and every bit of the 48-bit signature (up to 3 bits at a time, if 3 bits tolerance is allowed) to be considered as possibly “offending”. This would give rise to very large number of permutations to be taken into account.

Another factor which may be taken into consideration in relation in particular to audio signatures is that the accuracy of the oscillators used in household monitoring equipment will affect the accuracy of the digital signatures produced. This can be understood by considering the use of a 10 second window (segment or sample length) to collect bits for a digital signature. If the sampling clocks of the equipment (meters) in two separate households are not exactly the same frequency (or not exactly the same frequency as a sampling clock used to generate reference signatures), then the further away one is from a sync location or sync point, the greater the chance that the audio will exhibit an ‘accordion’ effect causing the bits at the end of the 10 seconds to be wrong or different. This is typically not a problem if the window of interest is kept under 1 second.

In embodiments of the present invention it may be provided that digital signatures, for example digital audio signals, of different bit lengths are generated for each sample, for example using the same means or steps for filtering, polarizing and scanning for synchronisation events, but using two different Digital Signature Collection Patterns (DSCPs), one to produce a short signature of relatively few bits, the other to produce a longer signature. Lookup in the reference database may that first be effected on the basis of short signatures, to rapidly exclude many “non-matches”, so that final matching, using long signatures, can be completed more quickly.

In embodiments of the present invention the digital signatures, i.e. the bits of the digital signatures, may be treated in different ways. In some embodiments the binary signatures, i.e. the bits of the signature are treated as representing a number, as mentioned above. The binary number may be converted to a decimal number so that a direct lookup can be used, which is a very fast way to look something up in a database. In other embodiments the signatures are retained in binary format and compared (bitwise, i.e. bit for bit) with every signature in the database. If the comparison results in just a few bits being different then there is good confidence that there is match, as discussed above. This builds tolerance into the system.

A further method that can be used for lookup when signatures are compared bit by bit is to generate possible permutations of each obtained digital signature. This involves, for example, taking a 48 bit digital signature and alternating (reversing the value) of some of the bits. This could be bits considered more probable to be wrong (e.g. bits in the digital signature where situated ‘near’ a transition point of opposite polarity, as mentioned above). In this case permutations of the same digital signature can be generated, each one having say 1, 2, 3, or 4 bits different from the original. If a match with one of the permutations is found, e.g. in a reference signature database there is again good confidence that there is match, as discussed above, with tolerance in the system.

When using the number represented by the bits of a signature, it is still possible to provide a degree of tolerance by using a signature to generate more signatures that are similar (by only changing a few of the bits) and then converting these new signatures to numbers, for example decimal numbers. There are also cases in which a shorter—and hence less unique—signature (for example 24 bits instead of 48 bits, converted to a decimal number) can be used to locate many possible areas in the reference database where a match could have occurred and then using a more unique non-decimal or bit pattern system to compare digital signatures within a close proximity in the reference database.

Embodiments of the present invention have been described above primarily in the context of audience monitoring using equipment (meters) in households of an audience panel and a central office at which information from the households is collected and stored, for instance for comparison with reference signatures possibly generated at the central office and stored in a database. However, embodiments of the present invention concerned with audio or video signatures from programs may be put to use in different ways.

For example, embodiments of the present invention can be used for verifying program line-ups, e.g. whether a particular broadcast segment such as an advertisement is broadcast by a particular station or channel at an expected time, or used for determining whether a particular segment has been broadcast improperly at some time (e.g. without the permission of the owner of the relevant rights). In such applications, the database of reference signatures may be created from original material (original recording) of the segment or advertisement, supplied by the rights owner for example.

Further, embodiments of the present invention can be employed in any context in which an audio item, such as a part of a work of music, of unknown identity, is to be identified. Digital audio signatures produced from the unknown work in accordance with the present invention can be compared with the reference signatures in the database or library to identify the work. This is similarly the case for embodiments of the present invention where the data segments represent other than audio items.

It will be understood from the above that embodiments of the present invention can be put to use in contexts beyond the generation of audio or video signatures from programs. Very briefly, any input signal can replace the audio signal. It can be said that the present invention does not “care” what the input signal or data segment represents.

It will be understood that a characteristic of the present invention is that the sampling effected does not need to adhere to Nyquist because it is not intended to reproduce the audio or other input signal. Further, it is possible for embodiments of the present invention to operate without any front end filtering. However, the inventors have determined that sampling discrepancies may then be more likely to arise between two data streams (the stream from which the signature to be identified is generated and the stream from which a reference signature was generated), so that filtering is generally to be favoured.

By way of example, if operating with 8000 samples per second, and filtering at a low frequency with, for example a low pass filter at 100 Hz, the result is a signal whose highest frequency is 100 Hz, but sampling rate is still 8000 s/s. This would effect resolution negatively because over 100 ms of this signal there will be very few transitions and it will be difficult to collect a unique signature. Conversely, a high frequency is used for the low pass filter cut-off then there will likely be many transitions in 100 ms and it will be easy to generate a unique signature. In general, the higher the bandwidth of the filter, the more transitions in a given period of time, and the higher the resolution. However, at higher frequencies, problems may arise but that is only because of the ‘edge’ issue described with reference to FIG. 7. However, with appropriate measures it is possible to use higher frequencies and thereby increase the resolution, for example to a few 100 milliseconds.

It will be understood from the above that a method embodying the present invention involves generating digital signatures on the basis of digital signal processing. The processing can be effected by computer equipment programmed to carry out the processing. The present invention thus also relates to computer equipment programmed to carry out the method of the present invention. The invention further relates to a computer program which can cause computer equipment to carry out the method of the present invention. The present invention further relates to a storage medium storing such a computer program.

Although the invention has been described with respect to specific embodiments for a complete and clear disclosure, the appended claims are not to be thus limited but are to be construed as embodying suitable modifications and equivalents that may occur to one skilled in the art and which fairly fall within the basic teaching herein set forth.

What is claimed is:

1. A digital signature generation apparatus comprising:
a polarizer operable to produce a two-state signal having a bit sequence providing a binary representation of a sampled data segment;
an event detector operable to identify at least one event in the sampled data segment or in the two-state signal; and
a signature generator operable, on the basis of a predetermined signature collection pattern specifying a plurality of offsets from an identified event to select the values of the respective bits of the bit sequence at the bit positions specified by the offsets, and on the basis of those values to provide a digital signature characteristic of the sampled data segment.

2. The apparatus of claim 1, further comprising:
a digitizer, operable to digitize an analog data segment to provide the sampled data segment.

3. The apparatus of claim 1, further comprising:
a digital filter, arranged before the polarizer, operable to band pass or low pass filter the sampled data segment.

4. The apparatus of claim 1, wherein the polarizer is operable to convert every sample of the sampled data segment of value greater than zero to “1”, and every sample of the sampled data segment of value less than or equal to zero to “0”.

5. The apparatus of claim 1, wherein the polarizer is operable to provide the binary representation by reversing bit value, from “1” to “0” or vice versa, for every crest, positive or negative, in the sampled data segment.

6. The apparatus of claim 1, wherein the event detector detects an event corresponding to occurrence of a predetermined pattern in the bit sequence of the signal.

7. The apparatus of claim 1, wherein the event detector detects as the predetermined pattern a transition between “1” and “0” in the bit sequence.

8. The apparatus of claim 1, wherein the event detector detects a moving window of bits in the bit sequence and sums the number of 1's or 0's in that window, and detects an event corresponding to the sum having a certain value.

9. The apparatus of claim 8, wherein the certain value corresponds to half the total number of bits in the window, or falls within a predetermined range of the certain value.

10. The apparatus of claim 1, wherein the event detector detects an event corresponding to an occurrence of a predetermined pattern in the sampled data segment.

11. The apparatus of claim 10, wherein the predetermined pattern is a minimum or maximum.

12. The apparatus of claim 1, wherein the event detector detects every nth sampled bit, where n is an integer, as a synchronization event.

13. The apparatus of claim 1, further comprising an amplitude detector operable to detect amplitude maximums of the sampled data segment, the event detector being operable to identify as an event an occurrence of a predetermined pattern in the bit sequence next before or next after the time point of a detected amplitude maximum of the sampled data segment.

14. The apparatus of claim 1, wherein the digital signature is provided by a numerical value or a pattern represented by the values of respective bits of the bit sequence at the bit positions specified by the offsets, when those values are taken in a predetermined order as a sequence of binary digits, from most significant to least significant or vice versa.

15. The apparatus of claim 12, wherein the predetermined order is that of increasing offset of the bit positions from which the values originate.

16. The apparatus of claim 1, further comprising,
a time stamp generator operable to generate a time stamp indicating a time at which the digital signature was generated.

17. The apparatus of claim 1, wherein the sampled data segment comprises a sampled audio segment.

18. A method of generating a digital audio signature comprising:
polarizing a sampled data segment to produce a two-state signal having a bit sequence providing a binary representation of the sampled data segment;
detecting an event in the sampled data segment or in the two-state signal; and
selecting, on the basis of a predetermined signature collection pattern specifying a plurality of offsets from the detected event, the values of the respective bits of the bit sequence at the bit positions specified by the offsets, and on the basis of those values providing a digital signature characteristic of the sampled data segment.

19. The method of claim 18, further comprising digitizing an analog data segment to provide the sampled data segment.

20. The method of claim 18, further comprising, prior to polarizing, digitally low pass or band pass filtering the sampled data segment.

21. The method of claim 18, wherein the polarizing converts every sample of the sampled data segment of value greater than zero to “1”, and every sample of the sampled data segment of value less than or equal to zero to “0”.

22. The method of claim 18, wherein the polarizing provides the binary representation by reversing bit value, from “1” to “0” or vice versa, for every crest, positive or negative, in the sampled data segment.

23. The method of claim 18, comprising detecting as an event the occurrence of a predetermined pattern in the bit sequence of the signal.

24. The method of claim 23, wherein the predetermined pattern is a transition between “1” and “0” in the bit sequence.

25. The method of claim 18, comprising detecting a moving window of bits in the bit sequence and summing the number of 1's or 0's in that window, and detecting as an event the sum having a certain value.

26. The method of claim 25, wherein the certain value corresponds to half the total number of bits in the window, or falling within a predetermined range of the certain value.

27. The method of claim 18, comprising detecting as an event the occurrence of a predetermined pattern in the sampled data segment.

28. The method of claim 27, wherein the predetermined pattern is a minimum or a maximum.

29. The method of claim 18, comprising detecting as an event every nth sampled bit, where n is an integer.

30. The method of claim 18, further comprising detecting amplitude maximums of the sampled data segment, and identifying as an event an occurrence of a predetermined pattern in the bit sequence next before or next after the time point of a detected amplitude maximum of the sampled data segment.

31. The method of claim 18, comprising providing the digital signature as a numerical value or a pattern represented by the values of respective bits of the bit sequence at the bit positions specified by the offsets, when those values are taken in a predetermined order as a sequence of binary digits, from most significant to least significant or vice versa.

32. The method of claim 31, wherein the predetermined order is that of increasing offset of the bit positions from which the values originate.

33. The method of claim 18, further comprising generating a time stamp indicating a time at which the digital signature was generated.

34. The method of claim 18, wherein the sampled data segment comprises a sampled audio segment.

35. A computer-readable medium having computer-executable instructions that when executed perform a method of generating a digital audio signature comprising:
polarizing a sampled data segment to produce a two-state signal having a bit sequence providing a binary representation of the sampled data segment;
detecting an event in the sampled data segment or in the two-state signal; and
selecting, on the basis of a predetermined signature collection pattern specifying a plurality of offsets from the detected event, the values of the respective bits of the bit sequence at the bit positions specified by the offsets, and on the basis of those values providing a digital signature characteristic of the sampled data segment.

36. A system comprising:
a database comprising digital signatures generated by a method comprising:
(a) polarizing a sampled data segment to produce a two-state signal having a bit sequence providing a binary representation of the sampled data segment;
(b) detecting an event in the sampled data segment or in the two-state signal; and
(c) selecting, on the basis of a predetermined signature collection pattern specifying a plurality of offsets from the detected event, the values of the respective bits of the bit sequence at the bit positions specified by the offsets, and on the basis of those values providing a digital signature characteristic of the sampled data segment; and
a means for comparing a further digital signature, also generated by steps (a), (b), and (c), with digital signatures of the database, to seek a match between said further digital signature and a digital signature of the database.

37. The system of claim 36, wherein said further digital signature is compared bit-wise with the digital signatures of the database.

38. The system of claim 36, wherein said further digital signature is considered to match a compared digital signature of the database if the further digital signature and the compared digital signature concerned are bit-wise identical or differ only at selected bit positions of the signatures.

39. The system of claim 38, wherein the selected bit positions of the signatures are selected on the basis of proximity of the bits concerned, in the two-state signal from which said further signature is derived, to transitions in the two-state signal from one state to the other.

40. The system of claim 39, wherein the number of selected bit positions is restricted to a maximum of m bit positions, m being 1, 2, 3 or 4, other bit positions which would otherwise be selected on the said proximity basis being excluded as selected bit positions.

41. The system of claim 37, wherein permutations of said further digital signature are generated, differing at up to a predetermined number of bit positions from said further digital signature, and a match is considered to be found if said further digital signature or any of the generated permutations are bit-wise identical with a digital signature of the database.

42. The system of claim 41, wherein the permutations differ at up to a predetermined number of predetermined bit positions from said further digital signature.

43. The system of claim 42, wherein the predetermined bit positions are selected on the basis of proximity of the bits concerned, in the two-state signal from which said further signature is derived, to transitions in the two-state signal from one state to the other.

44. The system of claim 36, wherein said further digital signature is compared with digital signatures of the database using the numerical values of the compared signatures as represented by the values of respective bits the signatures, when those values are taken in a predetermined order as a sequence of binary digits, from most significant to least significant or vice versa.

45. The system of claim 44, wherein said further digital signature is considered to match a digital signature of the database if the further digital signatures and the digital signature of the database have the same numerical value or differ in numerical value by less than a predetermined amount.

46. The system of claim 36 further comprising:
a mechanism for generating a time stamp indicating a time at which the digital signature was generated; and
a means for comparing time stamps of the compared digital signatures.

47. An audience measurement system comprising:
in one or more households, household entertainment equipment being a program source configured to produce audio signals; and
an apparatus configured to generate digital audio signatures of sampled audio segments derived from the audio signals, the apparatus comprising:
a polarizer operable to produce a two-state signal having a bit sequence providing a binary representation of a sampled data segment;
an event detector operable to identify at least one event in the sampled data segment or in the two-state signal; and
a signature generator operable, on the basis of a predetermined signature collection pattern specifying a plurality of offsets from an individual event to select the values of the respective bits of the bit sequence at the bit positions specified by the offsets, and on the basis of those values to provide a digital signature characteristic of the sampled data segment.

48. The audience measurement system of claim 46, further comprising:
in a reference office, reference equipment for receiving a plurality of TV or radio programs or other reference program sources comprising audio; and
a second apparatus configured to generate digital audio signatures of sampled audio segments derived from the audio signals, the apparatus comprising:
a polarizer operable to produce a two-state signal having a bit sequence providing a binary representation of a sampled data segment;
an event detector operable to identify at least one event in the sampled data segment or in the two-state signal; and
a signature generator operable, on the basis of a predetermined signature collection pattern specifying a plurality of offsets from an individual event to select the values of the respective bits of the bit sequence at the bit positions specified by the offsets, and on the basis of those values to provide a digital signature characteristic of the sampled data segment, such that the apparatus is configured to generate reference digital audio signatures of sampled audio segments derived from the audio of the received programs or other reference program sources.

49. The audience measurement system of claim 48, further comprising:
in the reference office, a database of the reference digital audio signatures; and
a means for comparing a further digital audio signature, supplied to the reference office from a household, with the database to identify the further digital audio signal.
